(19) United States
(12) Patent Application Publication
(10) Pub. No.: US 2002/0020936 A1
(43) Pub. Date: Feb. 21, 2002

(54) HIGH SPEED BAG CLOSURE EXTRUSION

(76) Inventor: KENNETH A TONEY, MIDLAND, MI (US)

Correspondence Address: S.C. JOHNSON & SON, INC., 1525 HOWE STREET, RACINE, WI, 53403-2236, US

(21) Appl. No.: 09/217,159

(22) Filed: Dec. 21, 1998

(51) Int. Cl. B29C 47/88

(52) U.S. Cl. 264/177.19; 264/178 R; 264/210.5; 264/237

(57) ABSTRACT

Disclosed herein is a method for the high speed extrusion of profile ele-ments for home storage units such as reclosable thermoplastic bags. Interlocking elements or plastic zipper strips are extruded directly into a waterbath to be quenched, and drawn through said bath for a distance sufficient to cool said elements to below the softening point of the extruded material. Collection rates of from about 200 to about 350 linear feet per minute are achieved by passing the elements through a depth of at least 3 feet of water prior to their first contact with a solid handling element.

### TECHNICAL FIELD

The present invention relates to a method for the extrusion of plastic reclosable fasteners for plastic bags and the like, and particularly for a method of extruding closure profiles at high speed.

Plastic reclosable fasteners are well known in the home storage art, as being useful for sealing thermoplastic bags. Such bags typically employ a pair of interengageable or interlocking closure strips or profile elements positioned in opposed relationship across the open mouth of the bag. These mating profile elements, having confronting locking surfaces provided with interlocking channel and ridge, or complementary male and female cross-sectional elements, are forced into a mating relationship by pressing them together, such as with a slider.

As indicated, such fastener assemblies, in the form of a plastic zipper or interlocking elements, often include a slider to engage the zipper profiles. Typically, the plastic zippers include a pair of interlocking fastener elements, or profiles, which form a closure upon being pressed together by movement of the slider across the profiles in such a manner as to force the interlocking engagement of the male and female profiles. In the manufacture of thermoplastic film bags, a pair of these male and female fastener profiles extend along the mouth of the bag, and are adapted to be secured in any suitable manner to the flexible walls of the ther- moplastic film bag. These profiles may be integral marginal portions of such walls, or they may be separately extruded and subsequently attached to the walls along the mouth of the bag. It is this latter form of closure profile to which the present in- vention most closely relates.

A major difficulty in extrusion of closure profiles is obtaining a high rate of extrusion while also maintaining the profile shape. In the typical method for the extrusion of plastic strips, the extruded material, for example a low density polyethylene, leaves the die at a temperature above about 150° C., and is drawn through a quench bath, typically cool water, to solidify the extruded material to its desired shape, as well as to inhibit drawing stress. The quench bath is often in the form of a water trough, and the thermoplastic extrudate or strands travel counter-current to a stream of cooling water. Alternatively, the extruded form is extruded directly into a waterbath, in which it passes around a number of idler or guide rolls to obtain an adequate cooling path to achieve proper solidification. One problem of such apparatus is that through-put rates are limited by quench liquid temperature, and rates greater than about 100 feet per minute of extruded profile frequently result in misshapen or distorted product.

### BACKGROUND ART

The profiles of plastic zippers can take on various configurations. For example, U.S. Pat. No. 5,140,727 describes interlocking rib and groove elements, whereas U.S. Pat. No. 5,007,143 describes a zipper profile. U.S. Pat. No. 4,747,702 relates to profiles that are U-shaped with interlocking hooks.

U.S. Pat. No. 4,446,089 describes a waterbath extrusion process that first pulls the extruded strand horizontally around rolls, then into a variable depth waterbath. The melt strands are led into a trough, where they travel counter-current to a stream of cooling water. The bottom of the trough merges with a vertical pipe, into which the melt strands are led, in a variable loop, in order to obtain a greater length of cooling bath.

U.S. Pat. No. 3,095,606 is specifically directed to a method for cold drawing thermoplastic monofilaments, and discloses extrusion of molten polymer into a quench bath, and under a roller in the cooling bath. The method shown in FIG. 1 of the patent is typical of the prior art.

U.S. Pat. No. 3,258,515 teaches a process for quenching an extruded film wherein counter-rotating rolls deliver a concurrent flow of fresh cooling liquid to both surfaces of the film as it enters the quench bath. In this case, the rollers are at the surface of the water and incompletely submerged so as to establish the desired flow of cooling liquid.

In addition, U.S. Pat. Nos. 3,382,306, 3,474,062, 3,664,780, 3,822,333, and 3,946,094 all teach methods for extrusion of polymeric materials in which the extruded material is subjected to a quench bath.

U.S. Pat. No. 4,906,310 describes a post-applied zippered film extrusion process where the film and zipper lamination are cooled in a waterbath. In this patent, it is taught to continuously bond a thermoplastic film to a profiled fastener by passing the film over a curvilinear surface metal bar, while concurrently hot-extruding the fastener element, and contacting the two so as to obtain hot-fusing of the element to the film prior to immersion of the fused element and film substrate into a cooling waterbath.

Other aspects of the prior art relate to separately extruding the two mating elements of a plastic zipper, and winding the extruded closure profiles on separate spools from which they may be drawn as needed. Such wound elements may be unwound and fed as needed into position for bonding onto an advancing web of plastic web, either by heat sealing, fusing, or by adhesive bonding. Such methods are not considered part of the present invention.

### SUMMARY OF THE INVENTION

In one aspect, the invention is directed to a method for the high speed extrusion of a thermoplastic material. In another aspect, the invention relates to the manufacture of extruded closure profiles for reclosable plastic bags. A further aspect of the present invention is the high speed manufacture of polyethylene bags having zipper closures.

The present invention is directed to an extrusion process wherein an extruded thermoplastic profile element is passed into a quench waterbath having an adjustable depth for the first roller encountered by the extrudate after passage through the die. This roller is preferably from 3 to 5 feet or more below the surface of the quench bath, permitting complete cooling and setting of the extruded profile prior to contact with a solid handling element or object. Cooling of the extruded polymer to below the softening point or melting temperature thereof is achieved by this more lengthy quench, which permits extrusion speeds of at least 200 linear feet per minute, up to about 350 feet per minute or more. This invention lessens water temperature sensitivity, and provides zipper profiles of improved uniformity.

It is an object of the present invention to provide a method for the production of extruded thermoplastic, wherein the rate of product formation is a multiple of the presently available rates of production. It is a further object of the invention to provide a method for the high speed extrusion of thermoplastic profiles for zipper closures of improved uniformity. These and still other objects and advantages of the present invention will be apparent from the description which follows. The following description is merely of the preferred embodiments. Thus, the claims should be looked to in order to understand the full scope of the invention.

### BRIEF DESCRIPTION OF THE DRAWINGS

FIG. 1 is a plan view of a zipper extrusion waterbath and process in accordance with the present invention.

FIG. 2 is a plan view of a typical zipper extrusion waterbath and process according to the prior art.

FIGS. 3-8 are representative cross sectional views of extruded zipper profiles drawn at differing rates and depths of waterbath, demonstrating the effect of coolant depth prior to contact with the first roller.

### BEST MODES FOR CARRYING OUT THE INVENTION

The present invention provides a method for the high speed production of profiled fasteners or zipper elements, particularly suited for thermoplastic bags and the like. Such bags may be made from any suitable thermoplastic film, such as, for example, polyethylene or polypropylene, polyvinyl chloride, or ethylene vinyl acetate or equivalent material. Such bags are formed by a pair of flexible plastic sheets having a top edge with reclosable fastener means along the length thereof. Such fastener means extend along the mouth of the bag, and are adapted to be secured in any suitable manner to the flexible walls of the thermoplastic film bag. While the fastener means, or profile elements, may be integral marginal portions of such walls, it is preferred that they be extruded separately and thereafter attached to the walls along the mouth of the bag in a manner well known in the art. The manner of attaching these extruded profile elements to respective walls of the bag is well known, and does not form part of the present invention. The present invention is related to a method of preparing extruded profile elements, whereby the extruded material is subjected to waterbath quenching sufficient to cool the shaped material to below its softening or melting temperature before the extruded material comes into contact with any solid processing element. This is accomplished by extruding the profile elements as a continuous strip from a profiled hot extrusion die directly into a quench waterbath having a depth of water of from about 3 feet to about 5 feet, and then passing the strip around a roller. It has been found that if the extruded profile element passes through a water quench bath exceeding about 3 feet in depth prior to contact with the first roller, the roller has no apparent effect on the profile shape at take-up speeds of up to about 350 linear feet per minute. Conversely, when the water depth prior to contact with the first roller is less than about 2 feet, the extruded zipper profile is adversely effected by contact with the roller at take-up speeds of 200 feet per minute or less. The extruded profile may then be drawn out of the quench bath and passed to handling equipment in the manner known in the art. It is also to be noted that a vertical drop in the quench liquid is preferable to a horizontal run counter-current to a flowing stream of quench liquid, such as in a trough. Much less angular stress is placed upon the extruded profile while passing vertically through a quench bath than when it is subjected to gravitational forces during a horizontal run.

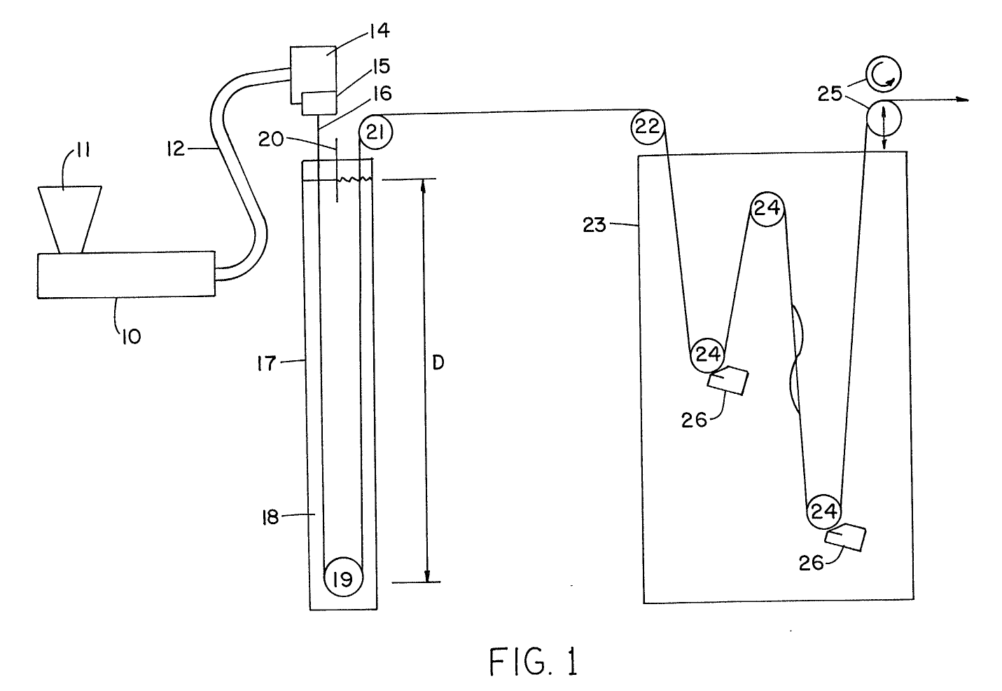

As illustrated in FIG. 1, thermoplastic resin is introduced to an extruder, 10, by way of hopper 11, and transferred via line 12 to a heated die, 14. Suitable thermoplastic materials may be selected from those materials suitable for the production of thermoplastic bags, such as polyethylene, polypropylene, ethylene vinyl acetate, substantially linear copolymers of ethylene and a C₃-C₈ I-olefin, polyvinyl chloride, mixtures of two or more of these polymers, or mixtures of one of these polymers with another thermoplastic polymer. The molten resin is passed through profile plate 15, under pressure, and extruded in the desired shape as determined by the plate orifice. The hot profile element, 16, is passed immediately into the quench bath 17, containing a quench liquid 18. The quench bath is generally filled with water, but other suitable fluid materials may be used. The coolant can be any liquid which is both physically and chemically inert toward the extruded element, i.e., the liquid neither dissolves, plasticizes, hardens, softens, nor chemically reacts with the extruded material. In addition to water, other liquids that can be employed would include ethylene glycol, diethylene glycol, ethers of these materials, glycerin, and the like. The particular liquid employed is not critical to the invention, but water is preferred due to its availability, low boiling point, low cost, good heat exchange capability, and environmental suitability. The quench bath may be replenished with cool quench liquid, 18, in the conventional manner, not shown, of flowing liquid counter-current to the movement of the extruded profile element, in from an inlet near the bottom of the quench bath container and out through an exit near the top. The hot profile element passes downward through the cooling medium, 18, for a distance D, to an idler roller 19, at which point the di- rection of movement of the profile element is reversed, and the profile element is drawn back to the top of the bath. A splash guard, 20, separates the entry and exit points of the profile element in the quench liquid, and limits the amount of quench liquid splashed upon the element prior to its entry into the quench bath. After leaving the quench bath, 17, the now cooled and solidified profile element, 16, is drawn by nip rolls 25 over guide rollers 21 and 22 to a dewatering station, 23, where the excess liquid clinging thereto is removed, by such means as airjets 26, and thence to collection means, not shown. The dewatering station may be, but is not necessarily heated, to assist in removal of quench liquid, and to heat treat the extruded profile.

The distance D, illustrated in FIG. 1, is preferably greater than about 3 feet, and more preferably from about 3 to about 5 feet. By positioning the first roller with which the extruded material comes in contact at a point more than three feet below the surface of the quench liquid, it has been found that the extruded material is cooled to below its softening temperature prior to being compressed against a solid surface. In this manner, distortion or mis-shaping of the profile element is minimized or eliminated. It is noted that the exact distance necessary to achieve this desired temperature drop is dependent upon a number of factors. Chief among these factors are the temperature of the extrusion, the temperature of the quench liquid, the thickness of the profile elements, and the rate of draw of the extruded element through the quench liquid. Other factors that contribute to this relationship are the coefficient of heat exchange between the extruded thermo- plastic material and the quench liquid, and the rate of replenishment of the quench liquid.

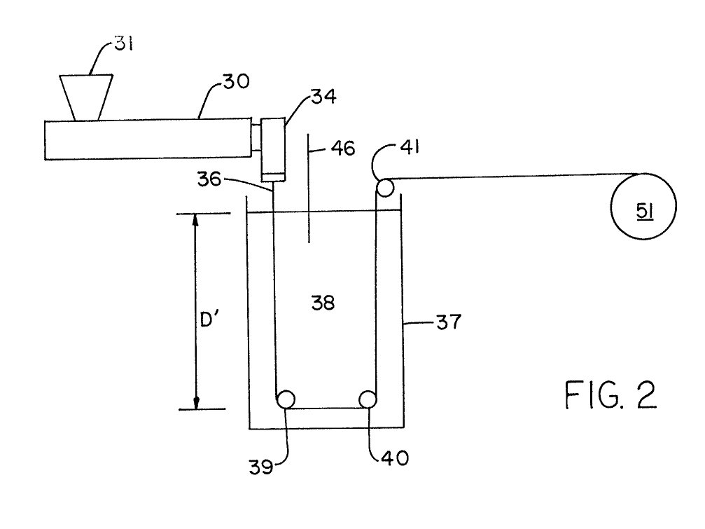

The invention as illustrated in FIG. 1 is to be contrasted with the conventional zipper extrusion means, shown in FIG. 2. In this latter instance, the thermoplastic resin is introduced to the extruder 30 by means of hopper 31, and passes through the die 34, into waterbath 37, containing the quench liquid 38, typically water. The extruded profile, 36, is passed downward in the waterbath to rolls 39 and 40, by which it is rerouted back to the surface. The depth, D', of the first roller 39 with which the extruded profile 36 comes into contact is typically from about 4 inches to about 24 inches. To achieve sufficient cooling of the extruded profile in accordance with this apparatus, the temperature of the quench liquid is much more critical, and is typically controlled by increased rates of replenishment or by a recirculation loop through a heat exchanger.

A splash guard 40 is present, as in FIG. 1, to limit undesired splashing of quench liquid on the extruded profile prior to entry thereof into the quench liquid. After exiting the quench bath, the extruded profile typically passes over idler roll 41 to be taken up at take-up reel 51.

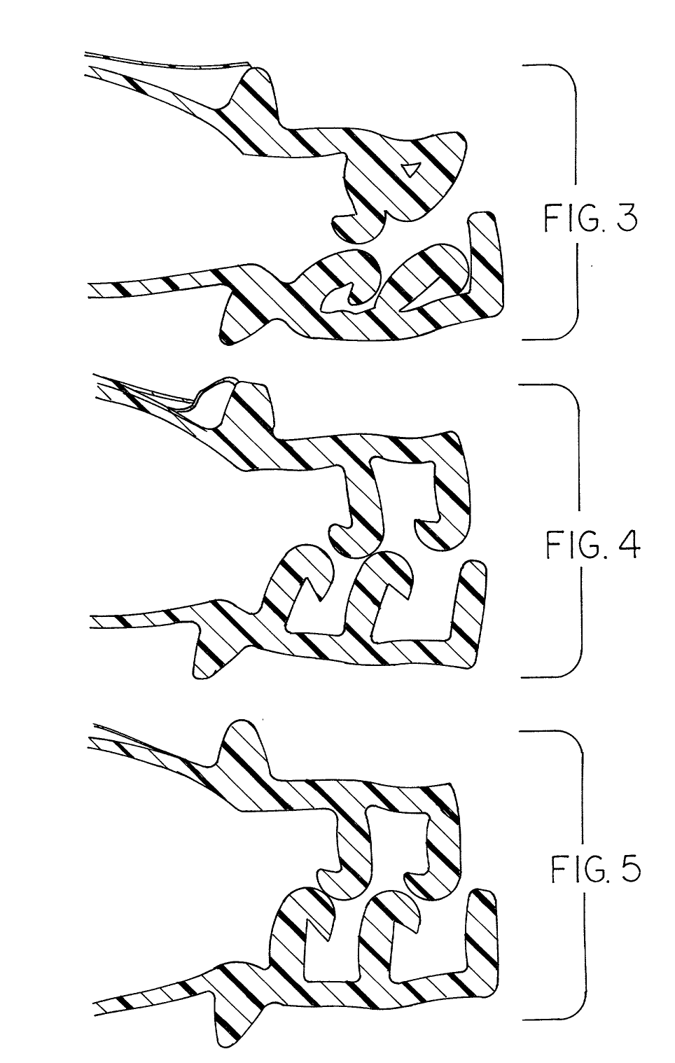

FIGS. 3-8 illustrate typical extrusion profiles drawn from the same profile plates into waterbaths having controlled replenishment rates, in accordance with the state of the art, and in accordance with the present invention. FIGS. 3, 4, and 5 represent drawings of zipper profiles extruded through a waterbath with a replenishment rate of 40 gallons per hour of water at 8.5° C. The exit temperature of the water was measured at 23° C., while the take-up speed of the extruded profile was 200 feet per minute. FIG. 3 represents the shape of the extruded profile with a measured distance, D, between the surface of the quench bath and the first submerged roller, of 1 foot. FIG. 4 represents the shape of the extruded profile with a measured distance between the surface of the quench bath and the first submerged roller of 2 feet, and FIG. 5 represents the shape of the extruded profile with a measured distance between the surface of the quench bath and the first submerged roller of 3 feet. It may be seen that at a rate of draw of 200 feet per minute through the bath, the zipper was not useable when the first contact of the extruded profile occurred at a 1 foot depth, questionable at a 2 foot depth, and acceptable at a 3 foot depth of bath. Zippers drawn through bath depths of 4 and 5 feet appeared the same as those drawn through a 3 foot bath.

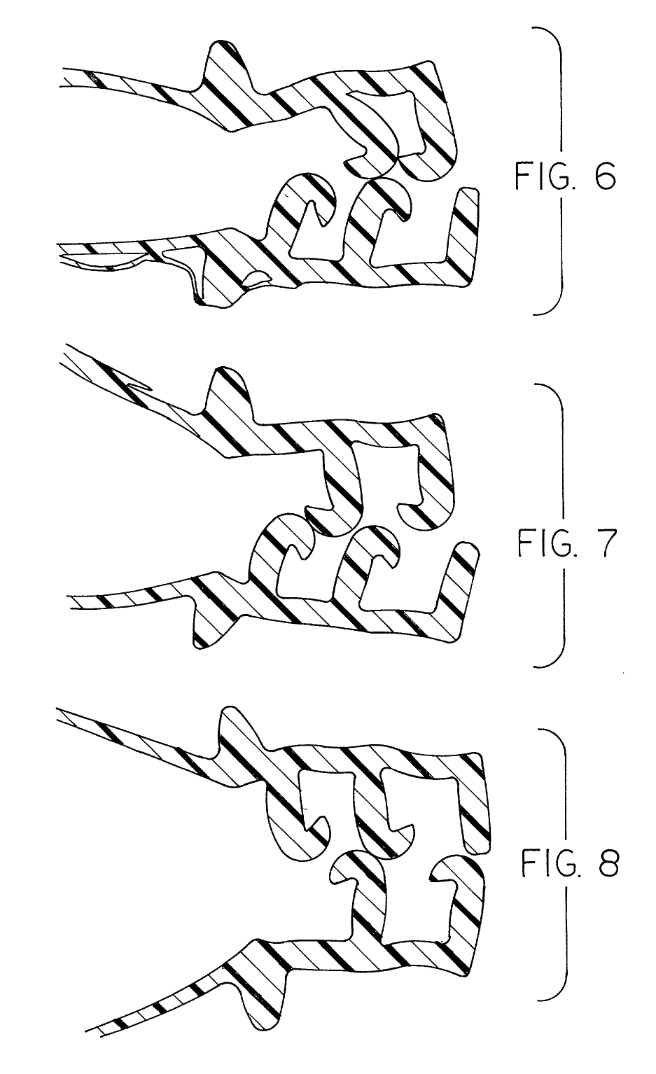

FIGS. 6, 7, and 8 represent drawings of typical zipper profiles extruded through a waterbath with a replenishment rate of 40 gallons per hour of water at 8.5° C. The exit temperature of the water was measured at 40° C., while the take-up speed of the extruded profile was 350 feet per minute. FIG. 6 represents the shape of the extruded profile with a measured distance, D, between the surface of the quench bath and the first submerged roller of 2 feet. FIG. 7 represents the shape of the extruded profile with a measured distance between the surface of the quench bath and the first submerged roller of 3 feet. FIG. 8 represents the shape of the extruded profile with a measured distance between the surface of the quench bath and the first submerged roller of 4 feet. It may be seen that at a rate of draw of 350 feet per minute through the bath, the zipper was not useable when the first contact of the extruded profile occurred at a 2 foot depth, questionable at a 3 foot depth, and acceptable at a 4 foot depth of bath or greater. Further, FIG. 8 illustrates the thickness of a zipper profile at two different points, as extruded in accordance with the present invention. As shown, this profile has dimensions of 0.012 inches and 0.020 inches at two critical locations. It has been observed that the ratios of submersion depth to thickness of profile should be between about 1000:1 and 6000:1, preferably between 1800:1 and 5000:1, and most preferably about 3000:1. For example, for the extrusion illustrated in FIG. 8, a ratio of 3000:1 was found for the 0.012 dimension at a take-up speed of 200 linear feet per minute at a roller depth of 2 feet, and 5000:1 at a take up speed of 350 feet per minute at a roller depth of 5 feet.. For the 0.020 dimension, a ratio of 1800:1 was obtained at 200 feet per minute at a roller depth of 3 feet, and a ratio of 5000:1 was obtained at 350 feet per minute at a roller depth of 5 feet.

The results of these experiments are shown in Table A, below, as well as in FIGS. 3-8, discussed above.

TABLE A

| Roller Depth | 200 fpm | 350 fpm |
|---|---|---|
| One foot | Unacceptable | |
| Two feet | Questionable | Unacceptable |
| Three feet | Acceptable | Questionable |
| Four feet | Acceptable | Acceptable |
| Five feet | Acceptable | Acceptable |

It was noted that when the first roller was more than 3 feet deep in the waterbath, the roller had little or no apparent effect upon the profile shape at speeds of 200 to 350 linear feet per minute of take-up speed. In addition, it was noted that with the first roller at a depth greater than 3 feet, the profile shape was not sensitive to waterbath temperature. That is, the profile was cooled sufficiently below its melt temperature before it contacted the roller that the shape was set, even at relatively high water temperatures, since even the boiling point of water is well below the 1200° C. melt temperature of typical zipper resins, such as low density polyethylene. Roller depths of greater than 5 feet would also work very well, but could potentially become cumbersome in operation, due to having to elevate the zipper die higher than 6 feet off the floor, or having to drop the bottom of the waterbath below the level of the floor to keep the die at a reasonable height. Typical waterbaths are less than 2 feet deep, wrap the zipper around a series of rollers in the water, and are very sensitive to water temperature.

Thus, it may be seen that high rates of production of profile elements for thermoplastic bag closures may be attained if the depth of the first roller contacting the extruded profile element in the quench bath exceeds about 3 feet, and preferably about 4 feet.

Industrial Applicability

The extrusion process of the present invention can be used in connection with the manufacture of thermoplastic parts and elements of various shapes and profiles, where the parts are produced by extrusion through a die to a specified configuration, and then quenched in a waterbath prior to further processing.

This process is particularly applicable to the manufacture of sealable plastic bags.

What I claim:

1. In a method for the extrusion of profile elements for reclosable thermoplastic storage containers comprising extruding said profile element directly into a quench bath and subsequently drawing the quenched extruded profile element from said bath, the improvement which comprises passing said element vertically through at least 3 feet of quench liquid at a rate of at least 200 linear feet per minute prior to contact with any solid handling element.

2. The improvement as set forth in claim 1, wherein said quench liquid comprises water, and said solid handling element comprises a roller in said quench bath.

3. The improvement as set forth in claim 2, wherein said extruded profile element comprises a thermoplastic material selected from the group consisting of polyethylene, polypropylene, ethylene vinyl acetate, substantially linear copolymers of ethylene and C₃-C₈ I-olefins, polyvinyl chloride, mixtures of two or more of these polymers, and mixtures of one of these polymers with another thermoplastic polymer.

4. The improvement as set forth in claim 3, wherein said element passes vertically through said water for a distance of from about 3 feet to about 5 feet prior to contact with said roller.

5. A method as set forth in claim 4, wherein the ratio of said distance to the thickness of the extruded profile is from about 1000:1 to about 6000:1.

6. A method as set forth in claim 4, wherein the ratio of said distance to the thickness of the extruded profile is from about 1800:1 to about 5000:1.

7. A method as set forth in claim 4, wherein the ratio of said distance to the thickness of the extruded profile is about 3000:1.

8. A method for the production of plastic zippers comprising extruding first and second interlocking profile elements through a profile plate directly into a waterbath, drawing said elements downwardly through said waterbath for a distance sufficient to cool said elements to a temperature below their softening point prior to passing said elements around a roller and withdrawing them from the waterbath at a rate of from about 200 to about 350 linear feet per minute.

9. A method as set forth in claim 8, wherein said elements comprise a thermoplastic material selected from the group consisting of polyethylene, polypropylene, ethylene vinyl acetate, substantially linear copolymers of ethylene and C₃-C₈ I-olefins, polyvinyl chloride, mixtures of two or more of these polymers, and mixtures of one of these polymers with another thermoplastic polymer.

10. A method as set forth in claim 9, wherein said distance is from about 3 feet to about 5 feet.

11. A method as set forth in claim 10, wherein the ratio of said distance to the thickness of the extruded profile is from about 1000:1 to about 6000:1.

12. A method as set forth in claim 10, wherein the ratio of said distance to the thickness of the extruded profile is from about 1800:1 to about 5000:1.

13. A method as set forth in claim 10, wherein the ratio of said distance to the thickness of the extruded profile is about 3000:1.
